(19) United States
(12) Patent Application Publication
(10) Pub. No.: US 2002/0103773 A1
(43) Pub. Date: Aug. 1, 2002

(54) Online system and method to purchase gases

(76) Inventors: Gil Ben-Dov, Morgan Hill, CA (US); Charles C. Henderson, Moraga, CA (US)

Correspondence Address: MORRISON & FOERSTER LLP, 2000 PENNSYLVANIA AVE, NW, SUITE 5500, WASHINGTON, DC, 20006-1888, US

(21) Appl. No.: 09/985,841

(22) Filed: Nov. 6, 2001

Related U.S. Application Data
(60) Provisional application No. 60/258,490, filed on Dec. 29, 2000.

(51) Int. Cl. G06F 17/60

(52) U.S. Cl. 705/413; 705/52; 705/26

(57) ABSTRACT

This invention provides applications and methods for organizing a web site. The web site allows online product research capability, online product development collaboration, and the ability to import content and format from foreign web sites without losing session.

### FIELD OF THE INVENTION

This invention relates generally to applications and methods for providing services over the internet, and, more specifically, to internet web sites featuring account access, product research capability, online product development collaboration, and the ability to import content and format from foreign web sites without losing session.

### BACKGROUND OF THE INVENTION

The internet now features many thousands of web sites where users can locate, research and/or purchase a virtually endless variety of products and services. However, the web sites in operation today fail to take full advantage of the power of the internet to develop and facilitate a full range of communication between vendors and customers.

First, when providing access to account information, current web sites generally allow a single user to simultaneously access multiple accounts, or allow multiple users to simultaneously access a single account, but do not support a combination in which multiple users can simultaneously access multiple accounts.

Second, current systems fail to direct a gas customer to a gas product that is appropriate for a particular application. A myriad of gas products may be used in a variety of applications. Determining a type of gas or gas product, and the amount appropriate for a particular application, can be a time consuming and complex process. Therefore, a system is needed to assist a user in determining which gas or gas products are best suited for their needs.

Third, current systems fail to provide a manner for a customer and a gas company to collaborate regarding uses of gas products. Thus, the gases and gas products offered by a gas company may not be best suited for customers' needs. Additionally, gas companies may be overlooking economic opportunities due to their lack of information about customers' needs.

Fourth, current systems fail to allow a user to maintain a current session when importing the contents of another web site into its wrapper. Thus, tracking software fails to accurately reflect a user's navigation of a system.

### SUMMARY OF THE INVENTION

This invention provides applications and methods for organizing a web site. The web site allows online product research capability, online product development collaboration, and the ability to import content and format from foreign web sites without losing session. The invention is described in relation to the specialty gas industry, but one will realize that the invention can be used in a variety of different circumstances.

In one embodiment, the invention provides an online gas selector application. The online gas selector application comprises a web site that has a series of questions related to the specialty gas industry. After a customer provides answers to the series of questions online, the gas selector application provides detailed information on one or more specialty gasses that meets the customer's needs.

Preferably, the series of questions asked to the customer changes according to the answers provided by the customer. Preferably, the gas selector application provides the price for the specialty gasses provided by the gas selector application. Preferably, the customer can purchase the specialty gasses provided by the gas selector application.

In another embodiment, the invention provides a method for providing information from a third party web page to a customer. The method comprises copying coded information from the third party web page, inserting the coded information from the third party web page into a seller's web page, and transferring the seller's web page that includes the coded information to a customer. Preferably, this embodiment allows a session between a customer and a seller to be maintained while the customer views information from the third party web page. Preferably, the third party information is information related to products the customer can purchase from the seller.

In another embodiment, the invention provides a method of managing customer accounts online. The method comprises providing customer account access to a customer and providing association account access to an association of customers. The association account access allows the association to access all or part of the accounts of customers who are members of the association. The customer account access allows the customer to access all or part of the accounts of associations to which the customer belongs.

Preferably, the customer is provided account access using a customer code. Preferably, the customer's access to the association accounts comprises pricing schemes that are dependent upon a customer's membership in an association.

### BRIEF DESCRIPTION OF THE DRAWINGS

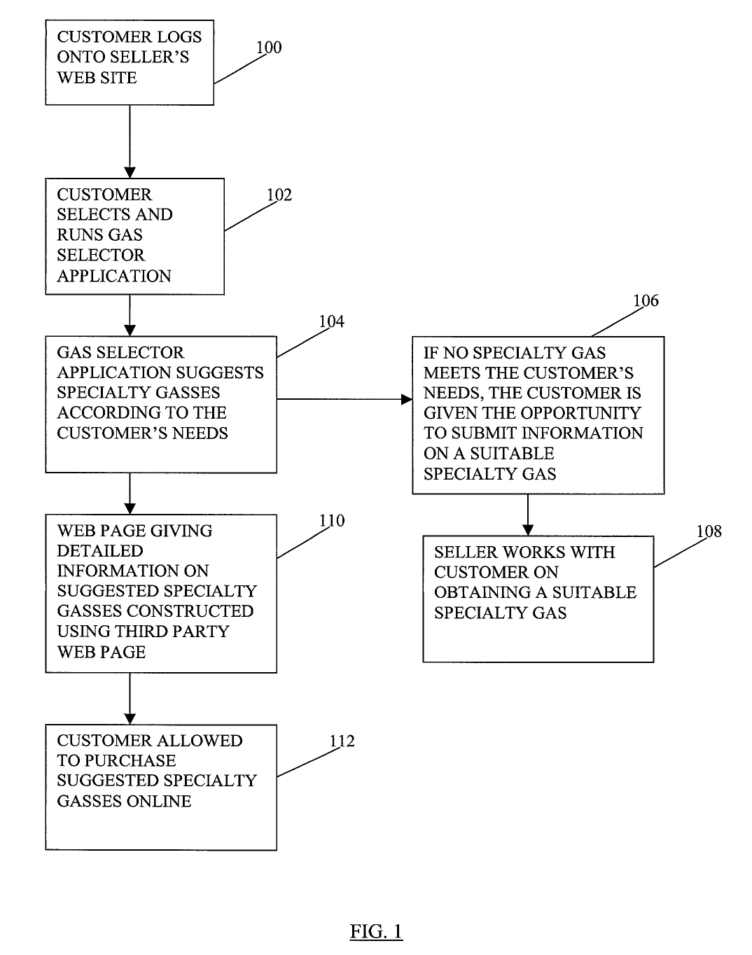

This invention will be better understood by reference to the Detailed Description of the Invention when taken together with the attached FIG. 1 of a flow diagram of one embodiment of the invention.

### DETAILED DESCRIPTION OF THE INVENTION

This invention specifically provides several innovations that facilitate online transactions between a seller and a buyer. The invention relates to sellers and buyers of a variety of products and services. In a preferred arrangement, a seller is an entity who sells specialty gasses and gas related services, and a customer is an entity who buys specialty gasses and gas related services.

Specialty gasses are gasses that have been prepared for sale to customers. Specialty gasses can include common gasses such as nitrogen and oxygen, along with more rare and limited gasses. Specialty gasses are used for a wide variety of applications in industry and research. As both the types of specialty gasses and the applications for these gasses grow and change in the future, choosing the right gas for a specific application will become more difficult.

This invention provides several components that can be used alone or together in any combination, to aid a specialty gas customer in choosing a specialty gas that is best for their application, finding information on specialty gasses, purchasing specialty gases from a seller, and requesting specific specialty gas products. The disclosed components can be placed online on a seller's web site to facilitate the online sale of specialty gasses. A seller's web site has one or more web pages.

The first component of the invention is an online gas selector application. The online gas selector application assists customers in determining which gas products are best suited for a particular use or application. The gas selector application comprises a series of questions that go from broad to specific. Preferably, the next question provided by the gas selector application is dictated by the answer provided by the customer to the previous question. The seller can map out the answers to each question series to provide one or more specialty gas products that will suit the customer's needs according to the answers provided by the customer.

Preferably, the gas selector application provides detailed information about each specialty gas product recommend by the application. Detailed information on the specialty gas can include, for example, the composition, the purity, the price, the volume, the weight, and the product code.

According to one aspect of the first component, the gas selector application is placed on a seller's web site. A customer then accesses the gas selector application online by going to the seller's web site. According to this aspect of the invention, the specialty gas seller can update the gas selector application at a web server. Preferably, the customer can accesses the gas selector application online using a common web browser program, for example Microsoft Explorer (TM) or Netscape Navigator (TM). By having the gas selector application accessible to customers through the seller's web site, expanding and updating the gas selector application can be accomplished by the seller quickly and efficiently, without having to contact the customers to notify them of the updates.

According to another aspect of the first component, the gas selector application gives the customer pricing information on the specialty gasses that meets the customer's requirements, and allows the customer to purchase the specialty gasses online.

Preferably, the seller tracks the purchases of the customer. Preferably, a customer's purchasing information is accessible to the customer online at the seller's web site. Preferably, the pricing information is customer specific. If the customer is entitled to special pricing, for example volume discounts, preferably this will be reflected in the price reflected by the gas selector application.

Preferably, the gas selector application allows the customer to enter all necessary information to complete the sale online. Necessary information can include, for example, quantity of specialty gas desired, customer identification, customer billing information, and method of delivery.

A second component of the invention provides a method for importing information from a third party web site into a seller's web site. Preferably, information from a third party web site is imported into the gas selector application portion of the web site. According to the second component of the invention, the customer can obtain information from third party sources without leaving the seller's web site and losing session.

“Session” refers to a series of customer selections on a seller's web site at a particular time. A customer's selections include all web pages the customer chooses to visit on the seller's web site and all actions taken by the customer on these web pages. Actions can include, for example, submitting answers to questions, submitting customer identification information, and submitting an order. Preferably, the seller records selections that occur during a customer's session.

A customer's session can begin in a variety of ways. For example, a customer's session can automatically begin when a customer goes to a seller's web site. Alternatively, a session can begin when a customer goes to a seller's web site and log's into the web site.

A session can end in a variety of ways. For example, a session can end when a customer logs out of the seller's web site. Alternatively, a session can end when a customer leaves the seller's web site and goes to a third party's web site.

Maintaining session allows the seller to track and store the customer's selections while connected to the seller's web site. This can be important for a variety of reasons. For example, if the customer selects to buy one or more items while on the seller's web site, the customer's selections can be tracked without having to complete the sale. Preferably, as long as the session has not ended, the customer's selections can be changed, for example by deleting an earlier selection or by adding further selections.

According to one aspect of the second component of the invention, the session between the seller and the customer is maintained by including identification text that identifies a particular customer in each web page. According to this aspect of the invention, the identification text is unique to each customer who has an open session.

Preferably, when a customer makes a selection from a seller's web page, the identification text and information concerning what selection was made by the customer is transmitted to the seller. The seller can keep track of the customer's selection by matching the customer identification text to selections the customer has made during the open session. Preferably, the seller stores the customer's selection and the identification text.

According to the second component of the invention, a script is used to capture the code of a third party web site. The code is then used to construct a web page at the seller's web site. The seller's web page includes information captured from the third party web site, along with code from the seller's web site. Preferably, the code from the seller's web site includes text that allows the session to be maintained. Preferably, the customer's web browser never leaves the seller's web site so that session is maintained.

A third component of the invention provides a customer management configuration that allows one-to-many and many-to-one account access. According to this customer management configuration, a single customer can access account information related to several accounts. Alternatively, an account that relates to several customers can be accessed by a association manager. Preferably, these accesses may be asynchronous or concurrent.

According to one aspect of the third component of the invention, a single customer can access account information related to several accounts. For example, a single customer may purchase goods and services from a seller using a variety of pricing schemes associated with a variety of accounts. According to this aspect of the invention, a single customer could be a member of one or more customer associations. The customer associations could be groups of customers that come together to buy goods and services together. The associations may be commonly or separately owned. By purchasing as an association, a customer could gain volume discounts from a seller.

Preferably, a customer can access all accounts to which they are members with concurrently. Preferably, a customer is assigned a customer code. The customer code could be for example, a name and/or password the customer uses to sign on to a seller's web site. Once the seller's web site identifies the customer using the customer code, preferably the customer is allowed access to all accounts to which they are associated with.

The customer's access to associated accounts may be limited. According to this aspect of the invention, the seller's web site may only provide access to pricing schemes dependent upon a customer's membership in one or more associations. Preferably, when the customer is ready to purchase products the seller's web site automatically provides clients prices depending on the accounts that they are associated with.

According to a second aspect of the third component of the invention, a customer association can gain access to all customer accounts that are members of the association. An association can be any group of two or more customers. For example, the customer's in the association may be different divisions in a single company, different locations of a single company, a franchise, or different companies that purchase together.

Preferably, the association itself is assigned a customer code. The association's customer code is linked to a variety of individual customer accounts. When the association signs onto the seller's web site using its customer code, the association can gain access to the individual customer accounts that are associated with the association.

According to this aspect of the invention an association could track the purchases of each member customer and the association could purchase goods for one or more member customers. The association's access to the individual customer accounts may be complete or limited.

A fourth component of the invention is an application that allows a customer to submit product development requests online. This application allows customers to collaborate with a seller to design targeted products. With this feature, the customer can submit online requests for unavailable products. The requests could include, for example, summaries or abstracts of recently published or patented gasses, gas products, processes or applications and suggested commercial uses. Customers and sellers can then collaborate with one another online to design products in accordance with the customer's business needs.

Alternatively, a seller can place on its web site published works, such as abstracts, articles and patents, that relate to potential products and technology. Prospective customer's can view this published information online and contact the seller if they have uses for these products and technologies.

The present invention will be better understood with reference to FIG. 1, a flow chart of one embodiment of the invention. The figure is intended to illustrate a specific embodiment within the overall scope of the invention as claimed. According to the embodiment shown in FIG. 1, a customer first logs onto a seller's web site 100. By logging into the web site 100, the customer can gain access to one or more accounts associated with the customer. The customer then selects and runs the gas selector application 102, which is online at the seller's web site. The gas selector application asks the customer a series of questions and then suggests a specialty gas according to the customer's needs 104.

If a specialty gas that meets the customer's needs is unavailable, the customer is given the opportunity to submit information on a suitable gas 106. The seller and the customer then work together on obtaining a suitable specialty gas that meets the customer's needs 108.

If one or more specialty gasses are available that meets the customer's needs, a web page on the seller's web site is created using information from a third party web page 110. The web page 110 has specific information on the suggested specialty gasses. A customer can view the web page 110 without leaving the seller's web site and without losing session. The customer is then allowed to purchase the suggested specialty gasses online 112.

Although the invention has been described relative to particular components, one of skill in the art will appreciate that this description is merely exemplary and the system and method of this invention may include additional or different components.

What is claimed is:

1. An online gas selector application comprising:
a web site comprising a series of questions related to the specialty gas industry, wherein a customer provides answers to the series of questions online, and wherein the gas selector application provides detailed information on one or more specialty gasses in response to the answers provided by the customer.

2. The gas selector application of claim 1, wherein the series of questions changes according to the answers provided by the customer.

3. The gas selector application of claim 1, wherein the detailed information comprises the price of the specialty gas.

4. The gas selector application of claim 1, wherein the customer can purchase the specialty gasses provided by the gas selector application.

5. A method of providing information from a third party web page to a customer comprising:
providing a third party web page;
copying coded information from the third party web page;
inserting the coded information from the third party web page into a seller's web page;
transferring the seller's web page that includes the coded information from the third party web page to a customer.

6. The method of claim 5, wherein the session between the customer and the seller is maintained while viewing the coded information from the third party web page.

7. The method of claim 5, wherein the third party information is information related to products the customer can purchase from the seller.

8. A method of managing customer accounts online comprising:
providing customer account access to a customer;
providing association account access to an association of customers, wherein the association account access allows the association to access all or part of the accounts of customers who are members of the association, and wherein the customer account access allows the customer to access all or part of the accounts of associations to which the customer belongs.

9. The method of claim 8, wherein the customer is provided account access using a customer code.

10. The method of claim 8, wherein the customer's access to the association accounts comprises pricing schemes that are dependent upon a customer's membership in an association.
